(19) United States
(12) Patent Application Publication
(10) Pub. No.: US 2009/0219256 A1
(43) Pub. Date: Sep. 3, 2009

(54) Systems and Methods for Resolving Multitouch Scenarios for Optical Touchscreens

(76) Inventor: John David Newton, Auckland (NZ)

Correspondence Address: JOHN S. PRATT, ESQ;KILPATRICK STOCKTON, LLP, 1100 PEACHTREE STREET, SUITE 2800, ATLANTA, GA, 30309, US

(21) Appl. No.: 12/368,372

(22) Filed: Feb. 10, 2009

(30) Foreign Application Priority Data
Feb. 11, 2008 (NZ) 565808

(51) Int. Cl. G06F 3/041

(52) U.S. Cl. 345/173

(57) ABSTRACT

An optical touch detection system may rely on triangulating points in a touch area based on the direction of shadows cast by an object interrupting light in the touch area. When two interruptions occur simultaneously, ghost points and true touch points triangulated from the shadows can be distinguished from one another without resort to additional light detectors. In some embodiments, a distance from a touch point to a single light detector can be determined or estimated based on a change in the length of a shadow detected by a light detector when multiple light sources are used. Based on the distance, the true touch points can be identified by comparing the distance as determined from shadow extension to a distance calculated from the triangulated location of the touch points.

### PRIORITY CLAIM

This application claims priority to New Zealand Provisional Patent Application No. 565,808, filed on Feb. 11, 2008 and entitled OPTICAL TOUCHSCREEN RESOLVING MULTITOUCH, which is hereby incorporated by reference herein in its entirety.

### TECHNICAL FIELD

The present subject matter pertains to touch display systems that allow a user to interact with one or more processing devices by touching on or near a surface.

### BACKGROUND

FIG. 1 illustrates an example of an optical/infrared-based touch detection system 100 that relies on detection of light traveling in optical paths that lie in one or more detection planes in an area 104 (“touch area” herein) above the touched surface. FIG. 2 features a perspective view of a portion of system 100. For example, optical imaging for touch screens can use a combination of line-scan or area image cameras, digital signal processing, front or back illumination, and algorithms to determine a point or area of touch. In this example, two light detectors 102A and 102B are positioned to image a bezel 106 (represented at 106A, 106B, and 106C) positioned along one or more edges of the touch screen area. Light detectors 102, which may be line scan or area cameras, are oriented to track the movement of any object close to the surface of the touch screen by detecting the interruption of light returned to the light detector's field of view 110, with the field of view having an optical center 112.

As shown in FIG. 2, in some systems, the light can be emitted across the surface of the touch screen by IR-LED emitters 114 aligned along the optical axis of the light detector to detect the existence or non existence of light reflected by a retro-reflective surface 107 along an edge of touch area 104 via light returned through a window 116. As shown in FIG. 1 at 108, the retroreflective surface along the edges of touch area 104 returns light in the direction from which it originated.

As an alternative, the light may be emitted by components along one or more edges of touch area 104 that direct light across the touch area and into light detectors 102 in the absence of interruption by an object.

As shown in the perspective view of FIG. 2, if an object 118 (a stylus in this example) is interrupting light in the detection plane, the object will cast a shadow 120 on the bezel (106A in this example) which is registered as a decrease in light retroreflected by surface 107. In this particular example, light detector 102A would register the location of shadow 120 to determine the direction of the shadow cast on border 106A, while light detector 102B would register a shadow cast on the retroreflective surface on bezel portion 106B or 106C in its field of view.

FIG. 3 illustrates the geometry involved in the location of a touch point T relative to touch area 104 of system 100. Based on the interruption in detected light, touch point T can be triangulated from the intersection of two lines 122 and 124. Lines 122 and 124 correspond to a ray trace from the center of a shadow imaged by light detectors 102A and 102B to the corresponding detector location in detector 102A and 102B, respectively. The borders 121 and 123 of one shadow are illustrated with respect to light detected by detector 102B.

The distance W between light detectors 102A and 102B is known, and angles α and β can be determined from lines 122 and 124. Coordinates (X,Y) for touch point T can be determined by the expressions tan α=Y/X and tan β=Y/(W−X).

However, as shown at FIG. 4, problems can arise if two points are simultaneously touched, with “simultaneously” referring to touches that happen within a given time interval during which interruptions in light are evaluated.

FIG. 4 shows two touch points T1 and T2 and four resulting shadows 126, 128, 130, and 132 at the edges of touch area 104. Although the centerlines are not illustrated in this example, Point T1 can be triangulated from respective centerlines of shadows 126 and 128 as detected via light detectors 102A and 102B, respectively. Point T2 can be triangulated from centerlines of shadows 130 and 132 as detected via light detectors 102A and 102B, respectively. However, shadows 126 and 132 intersect at G1 and shadows 128 and 130 intersect at G2, and the centerlines of the shadows can triangulate to corresponding “ghost” points, which are all potential touch position coordinates. However, with only two light detectors, these “ghost points” are indistinguishable from the “true” touch points at which light in the touch area is actually interrupted.

### SUMMARY

Objects and advantages of the present subject matter will be apparent to one of ordinary skill in the art upon careful review of the present disclosure and/or practice of one or more embodiments of the claimed subject matter.

In accordance with one or more aspects of the present subject matter, ghost points and true touch points can be distinguished from one another without resort to additional light detectors. In some embodiments, a distance from a touch point to a single light detector can be determined or estimated based on a change in the length of a shadow detected by a light detector when multiple light sources and/or differing patterns of light are used. The distance can be used to validate one or more potential touch position coordinates.

For example, the shadow cast due to interruption of a first pattern of light from a primary light source can be measured. Then, a second pattern of light can be used to illuminate the touch area. The change in length of the shadow will be proportional to the distance from the point of interruption (i.e., the touch point) to the light detector. The second pattern of light may be emitted from a secondary light source or may be emitted by changing how light is emitted from the primary light source. Distances from possible touch points as determined from triangulation can be considered alongside the distance determined from shadow extension to determine which possible touch points are “true” touch points and which ones are “ghost” touch points.

### BRIEF DESCRIPTION OF THE DRAWINGS

A full and enabling disclosure including the best mode of practicing the appended claims and directed to one of ordinary skill in the art is set forth more particularly in the remainder of the specification. The specification makes reference to the following appended figures, in which use of like reference numerals in different features is intended to illustrate like or analogous components.

FIG. 1 is a block diagram illustrating an exemplary conventional touch screen system.

FIG. 2 is a perspective view of the system of FIG. 1.

FIG. 3 is a diagram illustrating the geometry involved in calculating touch points in a typical optical touch screen system.

FIG. 4 is a diagram illustrating the occurrence of “ghost points” when multiple simultaneous touches occur in an optical touch screen system.

FIG. 5 is a block diagram illustrating an exemplary touch detection system configured in accordance with one or more aspects of the present subject matter.

FIGS. 6A and 6B illustrate changes in shadows cast by different touch points due to interruption of light from a secondary illumination source.

FIGS. 7A and 7B illustrate the relationship between shadow extension length and light detector distance in closer detail.

FIG. 8 is a flowchart showing an exemplary method of resolving a multitouch scenario.

FIG. 9 is a diagram illustrating distances between potential touch points and estimated distances for actual touch points.

FIG. 10 is a block diagram illustrating an exemplary touchscreen system.

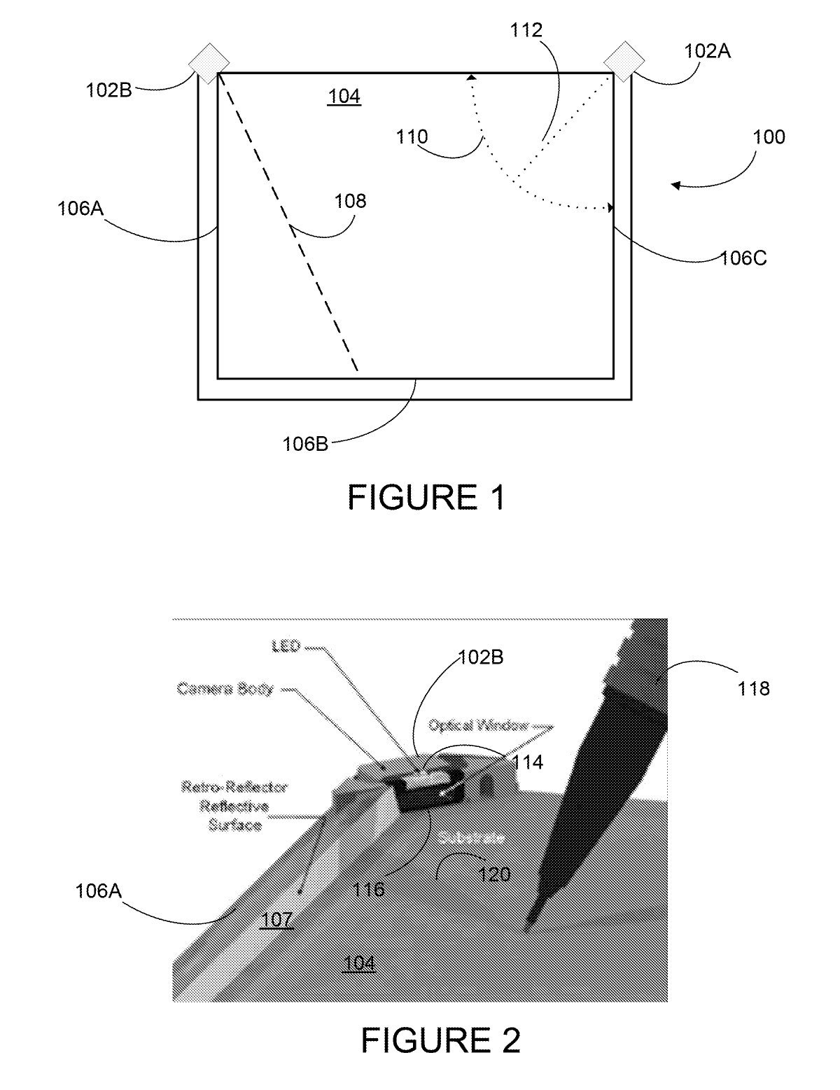

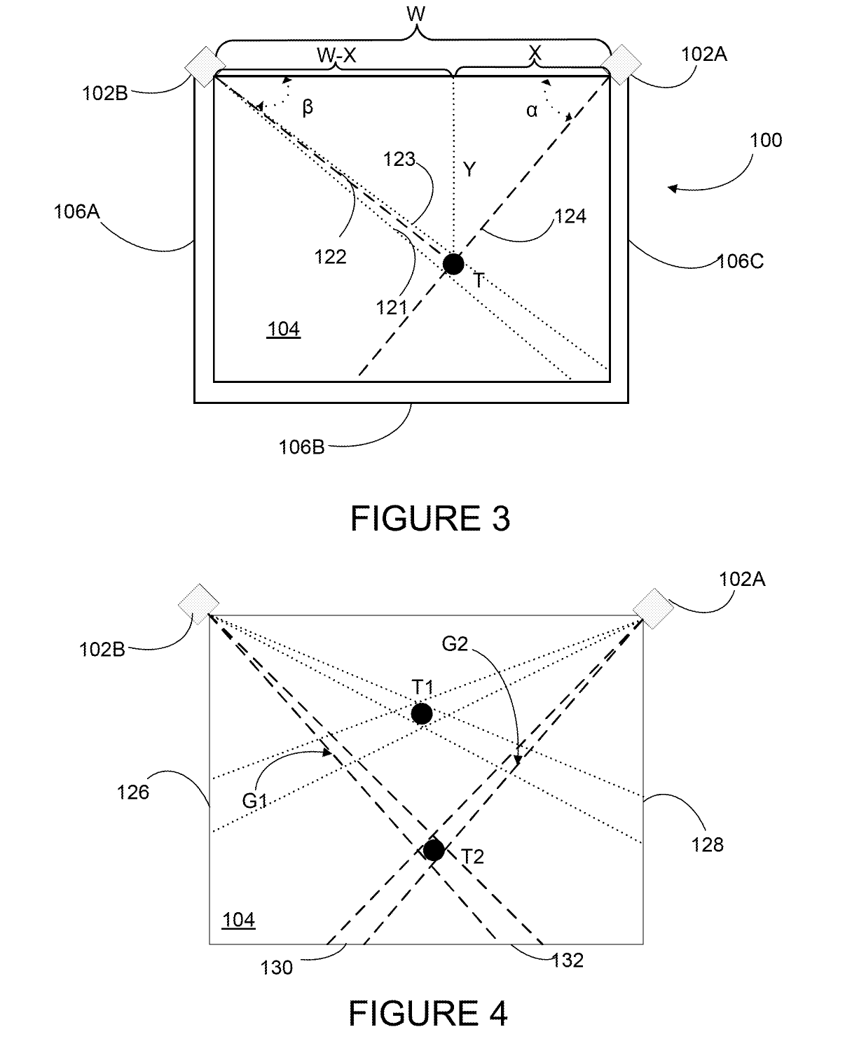

### DETAILED DESCRIPTION

Reference will now be made in detail to various and alternative exemplary embodiments and to the accompanying drawings. Each example is provided by way of explanation, and not as a limitation. It will be apparent to those skilled in the art that modifications and variations can be made without departing from the scope or spirit of the disclosure and claims. For instance, features illustrated or described as part of one embodiment may be used on another embodiment to yield still further embodiments. Thus, it is intended that the present disclosure includes any modifications and variations as come within the scope of the appended claims and their equivalents.

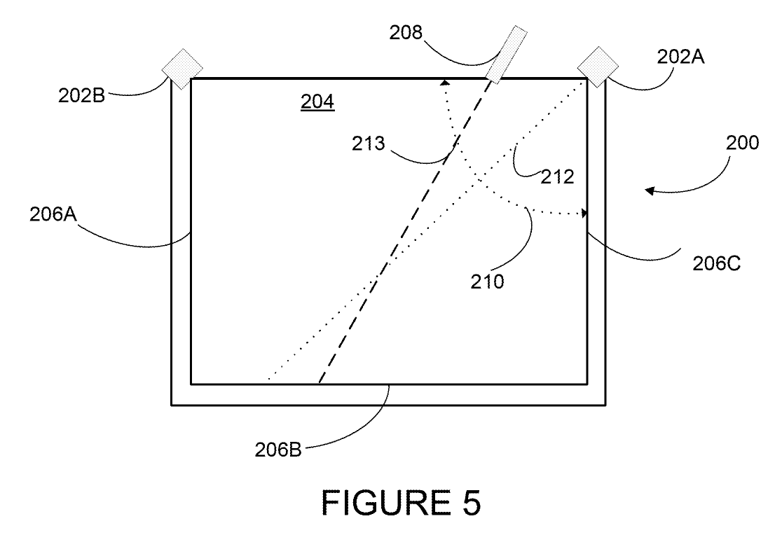

FIG. 5 is a block diagram illustrating an exemplary touch detection system 200 configured in accordance with one or more aspects of the present subject matter. In this example, two optical units 202A and 202B are positioned at comers of a touch area 204 bounded on three sides by a retroreflective bezel 206 having portions 206A, 206B, and 206C. Each optical unit 202 can comprise a light detector such as a line scan sensor, area image camera, or other suitable sensor. In this example, the optical units 202 also comprise a primary illumination system that emits light to illuminate a retroreflector that (in the absence of any interruptions in the touch area) returns the light to its point of origin. See, for instance, U.S. Pat. No. 6,362,468, which is incorporated by reference herein in its entirety.

The light detector of each optical unit 202 has a field of view 210 with an optical center shown by ray trace 212. The position of an interruption in the pattern of detected light relative to the optical center can be used to determine a direction of a shadow relative to the optical unit. As noted above, an interruption of light at a point in touch area 204 can correspond to a first shadow detected by one detector (e.g., the detector of optical unit 202A) and a second shadow detected by a second detector (e.g., the detector of optical unit 202B). By triangulating the shadows, the position of the interruption relative to touch area 204 can be determined.

FIG. 5 also illustrates a secondary illumination system 208. Secondary illumination system 208 comprises one or more sources of light positioned a known distance from the detector of optical unit 202B (and the detector of optical unit 202A). As illustrated by ray trace 213, secondary illumination system 208 emits light off-center relative to the optical center of the detector of either optical unit 202A or 202B in this example.

However, it is not necessary for the primary illumination source to be aligned with the optical center in all embodiments. Rather, light emitted across the touch area can be changed in any suitable manner so as to change shadow length. For example, both the primary and secondary illumination systems could be off-center relative to a detector. As another example, the secondary illumination may be on-center while the primary illumination is off-center.

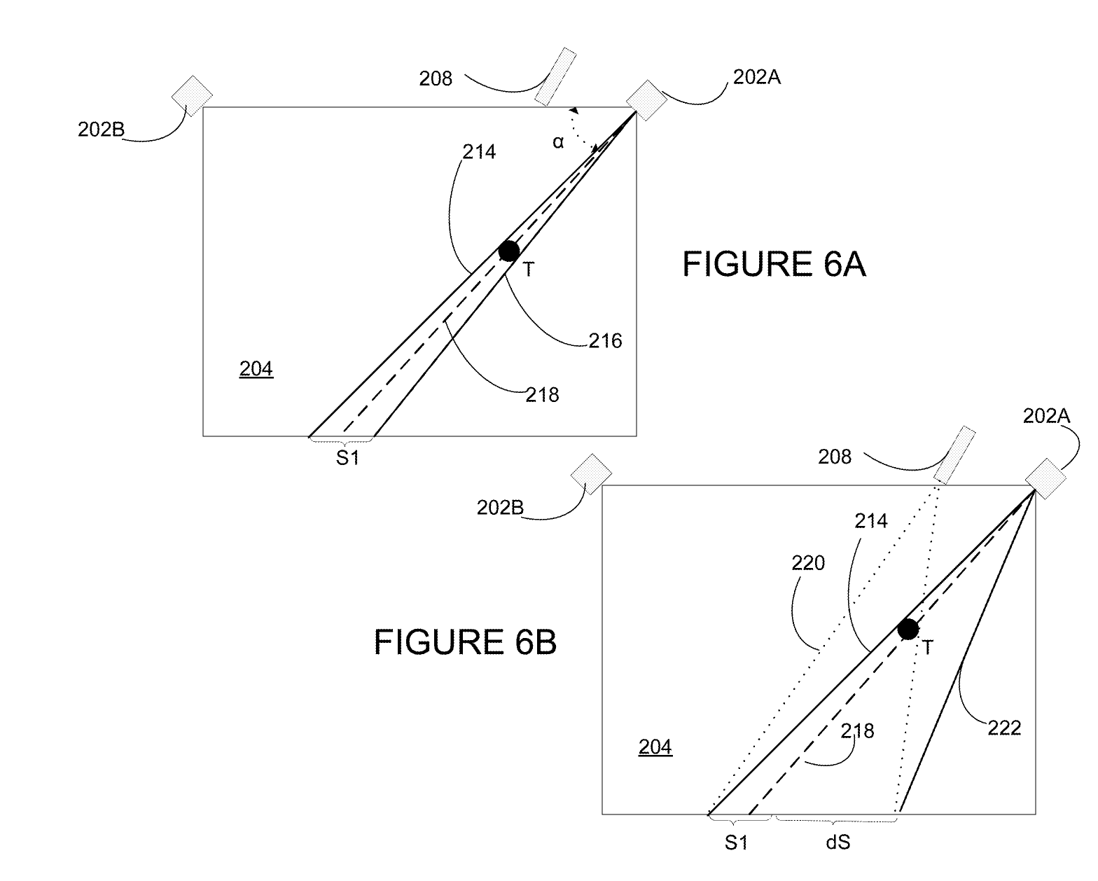

Distance estimates based on changes in shadow length can be used to resolve or confirm multitouch scenarios. FIGS. 6A and 6B illustrate changes in shadows cast by a touch point T due to interruption of light from a primary illumination source associated with optical unit 202A and secondary illumination source 208. In FIG. 6A, an interruption due to touch point T casts a shadow S1 having edges 214 and 216. An angle α can be determined based on a centerline 218 of shadow S1.

FIG. 6B shows that the illumination in touch area 204 has changed. Namely, light from secondary source 208 is emitted as represented by dotted lines 220. The detector of optical unit 202A images the resulting shadow cast due to the interruption at touch point T. Since secondary illumination source 208 is off-center relative to the detector of optical unit 202A, a different shadow is cast. Specifically, in this example, a larger shadow is cast, with the difference in shadow length along the edge of touch are 204 illustrated at dS. This lengthening effect is due to the fact that the shadow from the field of view of detector 202A has edges 214 and 222. Centerline 218 of the original shadow S1 is shown for reference.

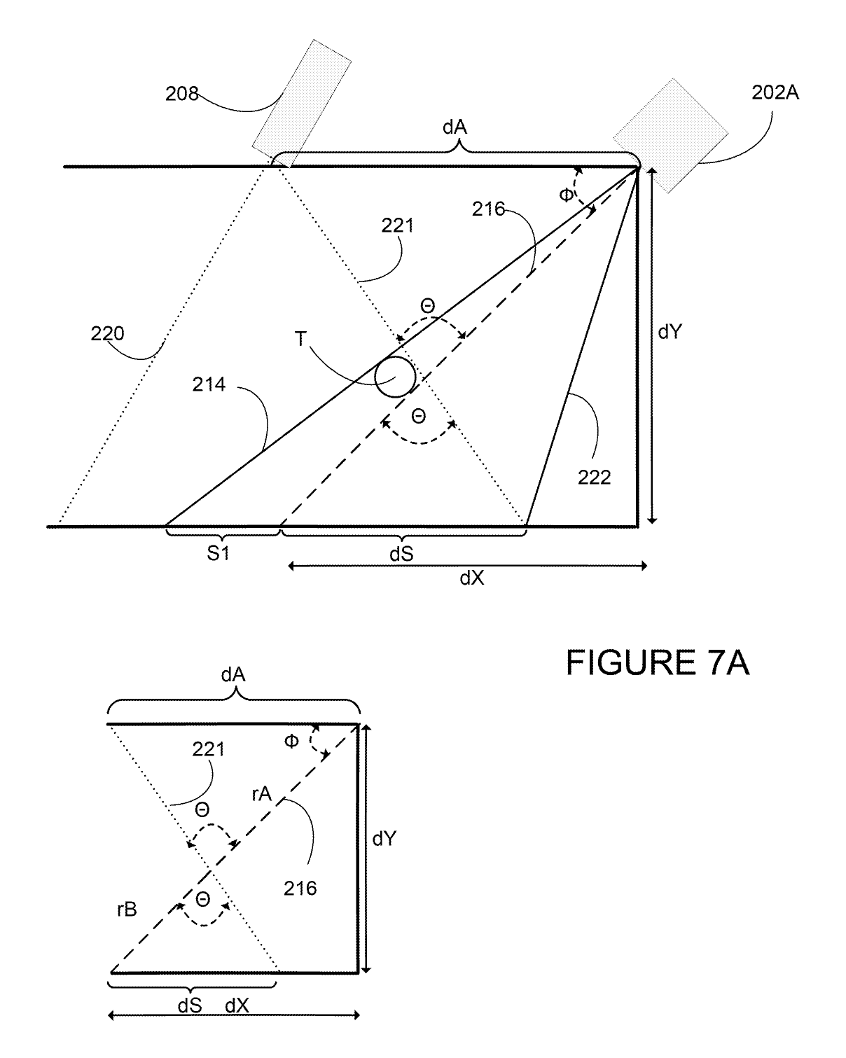

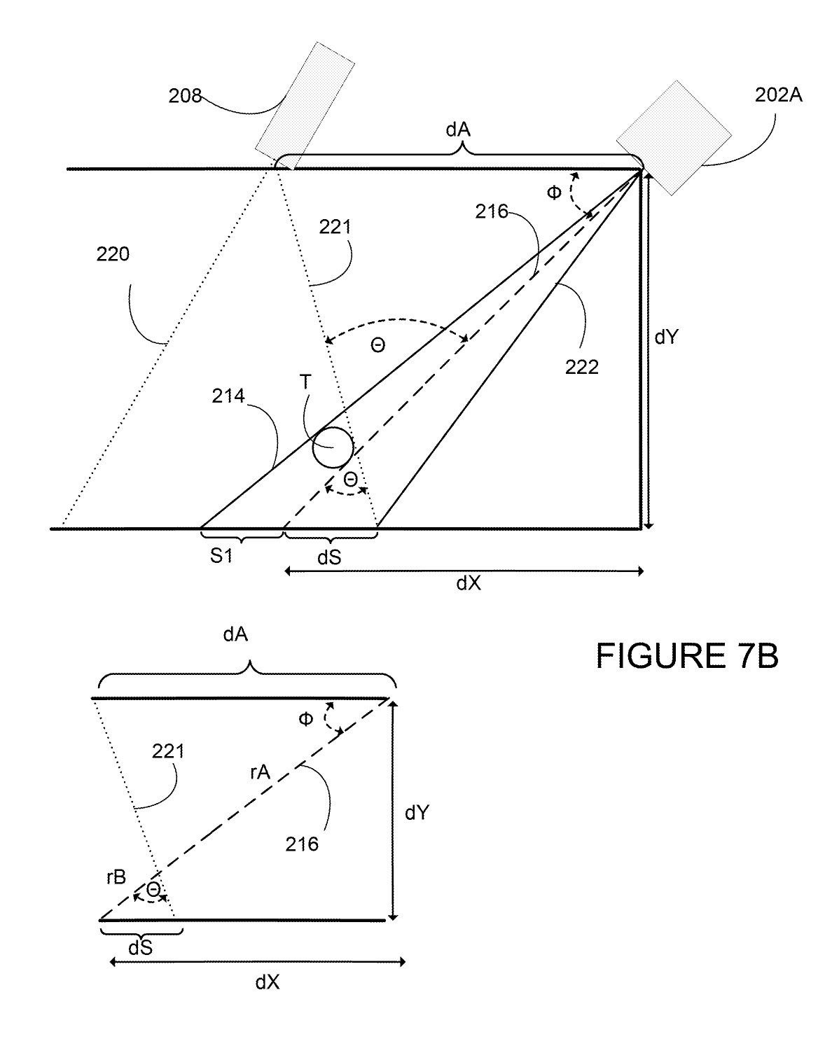

FIGS. 7A and 7B illustrate the geometry of the shadow length extension in closer detail for a case in which point T is relatively close to the detector of optical unit 202A (shown in FIG. 7A) and a case in which point T is farther from the detector of optical unit 202A (shown in FIG. 7B).

In each of these examples, illumination from secondary illumination source 208 is represented as ray traces 220 and 221 along with shadow edges 214 and 222 as seen in the field of view of detector 202A. Original shadow edge 216 (i.e. the shadow edge when light from the primary illumination system is interrupted) is shown for reference, along with the boundaries of S1 and shadow extension dS.

Each of FIGS. 7A and 7B include an inset illustrating distances dA (the distance between secondary illumination source 208 and the detector of optical unit 202A); distance dY (the length of one side of touch area 204), shadow extension length dS, and a length dX along the side of touch area 204 opposite length dA (but not necessarily equal to dA). An angle φ is shown representing the angle between the top side of touch area 204 and original shadow edge 216; this angle may be derived using a ray trace of the original shadow boundaries. An angle \hat{-} is also illustrated as formed from the intersection between shadow edge 216 and ray trace 221.

The intersection between shadow edge 216 and ray trace 221 can be treated as a proxy for the position of touch point T. Thus, portion rA of ray trace 216 can be treated as an estimate of the distance from the detector of optical unit 202A to touch point T. FIGS. 7A and 7B show that as the distance rA from T to optical unit 212A varies, the length dS varies, with dS being larger if T is closer to the detector in this example. Different patterns of light may result in dS becoming shorter as T moves closer to the detector, so the use of shadow “lengthening” in this example is not meant to be limiting.

Ray traces 221 and 216 form two sides of an upper triangle and a lower triangle. The third side of the upper triangle has a length equal to dA and the third side of the lower triangle has a length equal to dS. One side of the upper triangle has a length rA, while one side of the lower triangle has a length rB.

The upper and lower triangles formed by rays 216 and 220 are geometrically similar, and regardless of the distance from T to optical unit 212A, the following ratio holds:

rA/rB=dA/dS

Because the distance dA from the secondary illumination source 208 to the detector of optical unit 202B is known, then the distance RA from point P to optical unit 212B can be calculated or estimated as:

rA=rB*(dA/dS)

To solve for rA, rB can be expressed as a function of rA since the total length (rA+rB) from detector 202B to the bottom edge of touch area 204 is easily computed as the hypotenuse of a third (right) triangle formed by ray trace 216 (whose total length is RA+RB), vertical side Y (whose length is dY) of touch area 204 (which is known), and horizontal side having a length dX:

(rA+rB)=dY/sin Φ

rB=(dY/sin Φ)−rA

Following this, then:

rB=rA*(dS/dA)

rB=(dY/sin Φ)−RA

rA*(dS/dA)=(dY/sin Φ)−rA

rA*(1+dS/dA)=(dY/sin Φ)

Gives an estimation (rA) of the distance (or range) from the actual touch point to the detector:

rA=(dY/sin Φ)/(1+dS/dA)

The distance rA is referred to as an “estimation” because, in practice, the accuracy of the shadow length may vary with the distance of the interruption from the detector. This phenomenon is related to the variations in detection accuracy that can occur based on relative position in the touch area as is known in the art. Additionally, in this example, the intersection between ray 220 and 216 does not correspond to the center of point T.

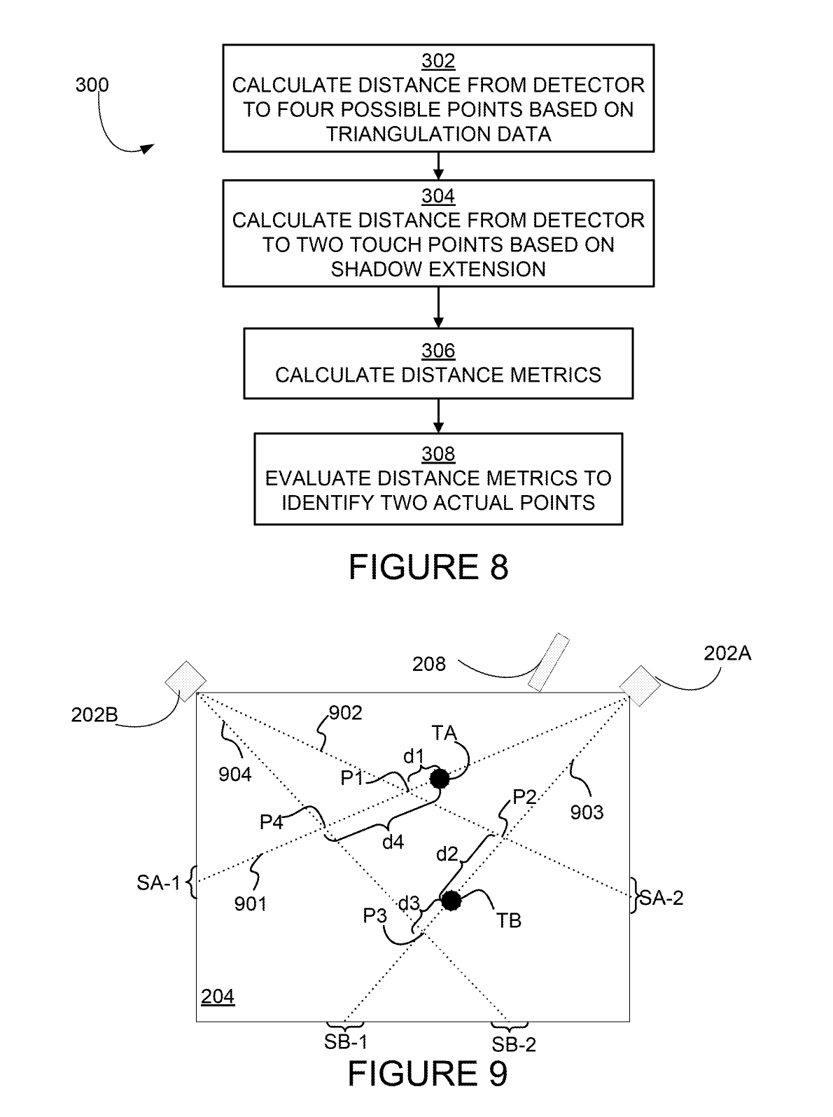

FIG. 8 is a flowchart showing an exemplary method 300 for resolving a multitouch scenario based on a distance determined using a secondary illumination system. FIG. 9 is a diagram illustrating distances between potential touch points and estimated ranges for actual touch points and will be discussed alongside FIG. 9.

As discussed below, distances estimated from changes in shadow size can validate potential touch coordinates, which in this example are calculated from triangulating shadows. However, this is for purposes of example only, and in embodiments one or more potential touch coordinates could be identified in any other suitable fashion and then validated using a technique based on shadow extension.

At block 302, a distance from the detector of to each of the four potential touch points is calculated. Four potential touch points can be identified based on the directions of shadows cast by simultaneous interruptions in light traveling across the touch area. For example, a first pattern of light may be used for determining the four points from triangulation.

FIG. 9 shows an example of four shadows having centerlines 901, 902, 903, and 904. A first shadow SA-1 having a centerline 901 results from an interruption of light at a first point TA in the touch area and is detected using a first detector (i.e. the detector of optical unit 202A). A second shadow SA-2 having a centerline 902 also results from the interruption at point PA and is detected using the detector of optical unit 202B. A third shadow SB-1 having a centerline 903 and a fourth shadow SB-2 having a centerline 904 are created by an interruption at point TB simultaneous to the interruption at point TA and are detected using the first and second detectors, respectively.

As noted above, two interruptions may be considered “simultaneous” if the interruptions occur within a given time window for light detection/touch location. For example, the interruptions may occur the same sampling interval or over multiple sampling intervals considered together. The interruptions may be caused by different objects (e.g., two fingers, a finger and a stylus, etc.) or different portions of the same object that intrude into the detection area at different locations, for example.

The centerlines intersect at four points corresponding to potential touch points P1, P2, P3, and P4. FIG. 9 also illustrates actual touch points “TA” and “TB” as solid circles. The relative position of the actual touch points to the potential touch points is not known to the touch detection system, however. The actual touch points may of course coincide with potential touch points but are shown in FIG. 9 as separate from potential touch points for purposes of illustrating exemplary method 300, which can be used to determine which triangulated touch points actually correspond to the interruptions in the touch area.

Block 302 in FIG. 8 represents calculating a distance from one of the detectors to each of the four potential touch points P1-P4. This distance (DistanceN) can be determined, for example, using the triangulated coordinates (X,Y) for each point (PN) using the following expression:

DISTANCE_{N}=\sqrt{X_{N}²+Y_{N}²}

Block 304 of FIG. 8 represents calculating an estimated distance from the detector to each of the two touch points based on identifying a shadow extension. This can be determined based on comparing the patterns of light detected by a single detector under a first illumination condition (e.g., a first pattern of light, such as a pattern of light from the detector's primary illumination source) and then changing the illumination to a second pattern of light (e.g., by illuminating using a secondary illumination system while the primary illumination is not used or changing the pattern of light emitted from the primary illumination system).

To determine a distance (Distance_{A}) from point TA to the detector of optical unit 202A in FIG. 9, a change in length of shadow SA-1 could be determined. To determine a distance (Distance_{B}) from point TB to the detector, a change in length of shadow SB-1 could be determined. A distance from each point to the detector can be determined using the expression solved above for rA based on the length of the respective shadow extensions as compared to the distance between the detector and the light source used to emit the second pattern of light.

Once the distance from each actual touch point to the detector is known or estimated, the actual ranges can be considered alongside the calculated ranges for the potential touch points P1-P4 to determine which touch points are actual touch points.

As shown at block 306 of FIG. 8, a distance metric can be calculated for use in identifying the “actual” touch points. A distance metric is used in some embodiments since a direct comparison between the calculated ranges and the ranges as determined by shadow length changes may lead to ambiguous results. For example, the coordinates of the triangulated touch points may result in multiple potential touch points having the same distance to a given detector. As another example, the calculated distance and distance for the same point as measured using shadow extension may not match exactly due to measurement or other inaccuracies. For instance, in some embodiments, the distance as determined based on shadow extension may be measured along a line tangent to the touch point, rather than a line passing through the center of the touch point, which could lead to a slight variation in the estimated distance as compared to the distance determined from triangulated coordinates.

In some embodiments, distance metrics Metric1 and Metric2 can be calculated for use in identifying the actual touch points as follows:

Metric1=d1+d3

Metric2=d2+d4

In this example, d1-d4 are arguments determined as follows by subtracting calculated distances from the detector:

d1=Distance₁−Distance_{A}

d2=Distance_{B}−Distance₂

d3=Distance₃−Distance_{B}

d4=Distance₄−Distance_{A}

At block 308, the distance metrics are evaluated to identify the two actual points. In this example, the actual points are P1 and P3 if Metric1<Metric2; otherwise, the actual points are P2 and P4.

The example above was carried out with reference to ranges from one of the detectors. In some embodiments, the process can be repeated to calculate ranges Distance₁ through Distance₄, Distance_{A}, and Distance_{B} relative to the other detector if necessary to resolve an ambiguous result and/or as an additional check to ensure accuracy.

In the example above, the actual touch points PA and PB as determined based on shadow extensions were each correlated to one of two potential touch points since the method assumes that two simultaneous shadows detected by the same detector each correspond to a unique touch point. Namely, actual point TA was correlated to one of potential touch points P1 and P3, while actual touch point TB was correlated to one of potential touch points P2 and P4. Variants of the distance metric could be used to accommodate different correlations or identities of the touch points.

Method 300 may be a sub-process in a larger routine for touch detection. For example, a conventional touch detection method may be modified to call an embodiment of method 300 to handle a multitouch scenario triggered by a detector identifying multiple simultaneous shadows or may be called in response to a triangulation calculation result identifying four potential touch points for a given sample interval. Once the “actual” points have been identified, the coordinates as determined from triangulation or other technique(s) can be used in any suitable manner.

For example, user interface or other components that handle input provided via a touchscreen can be configured to support multitouch gestures specified by reference to two simultaneous touch points. Although the examples herein referred to “touch” points, the same principles could be applied in another context, such as when a shadow is due to a “hover” with no actual contact with a touch surface.

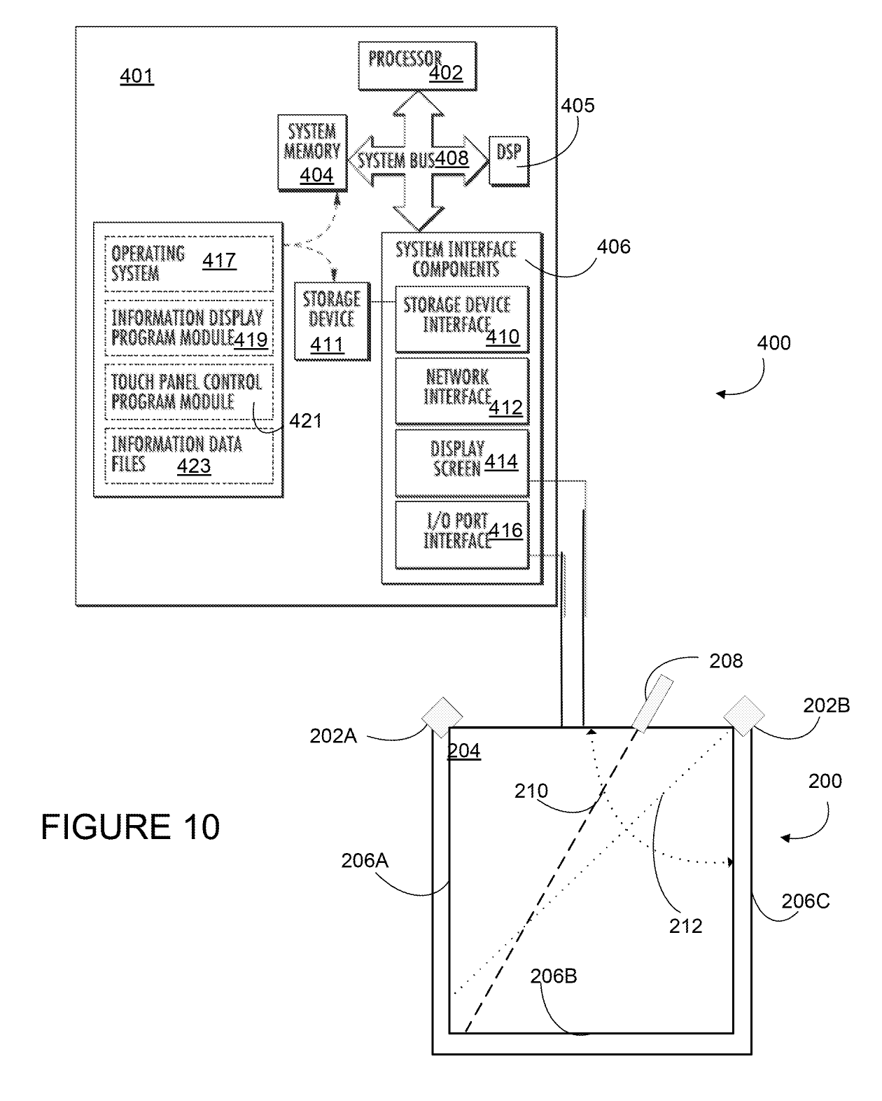

FIG. 10 is a block diagram illustrating an exemplary touch detection system 200 as interfaced to an exemplary computing device 401 to yield a touch screen system 400. Computing device 401 may be functionally coupled to touch screen system 410 by hardwire and/or wireless connections. Computing device 401 may be any suitable computing device, including, but not limited to a processor-driven device such as a personal computer, a laptop computer, a handheld computer, a personal digital assistant (PDA), a digital and/or cellular telephone, a pager, a video game device, etc. These and other types of processor-driven devices will be apparent to those of skill in the art. As used in this discussion, the term “processor” can refer to any type of programmable logic device, including a microprocessor or any other type of similar device.

Computing device 401 may include, for example, a processor 402, a system memory 404, and various system interface components 406. The processor 402, system memory 404, a digital signal processing (DSP) unit 405 and system interface components 406 may be functionally connected via a system bus 408. The system interface components 406 may enable the processor 402 to communicate with peripheral devices. For example, a storage device interface 410 can provide an interface between the processor 402 and a storage device 341 (removable and/or non-removable), such as a disk drive. A network interface 412 may also be provided as an interface between the processor 402 and a network communications device (not shown), so that the computing device 401 can be connected to a network.

A display screen interface 414 can provide an interface between the processor 402 and display device of the touch screen system. For instance, interface 414 may provide data in a suitable format for rendering by the display device over a DVI, VGA, or other suitable connection to a display positioned relative to touch detection system 200 so that touch area 204 corresponds to some or all of the display area. The display device may comprise a CRT, LCD, LED, or other suitable computer display, or may comprise a television, for example.

The screen may be is bounded by edges 206A, 206B, and 206D. A touch surface may correspond to the outer surface of the display or may correspond to the outer surface of a protective material positioned on the display. The touch surface may correspond to an area upon which the displayed image is projected from above or below the touch surface in some embodiments.

One or more input/output (“I/O”) port interfaces 416 may be provided as an interface between the processor 402 and various input and/or output devices. For example, the detection systems and illumination systems of touch detection system 200 may be connected to the computing device 401 and may provide input signals representing patterns of light detected by the detectors to the processor 402 via an input port interface 416. Similarly, the illumination systems and other components may be connected to the computing device 401 and may receive output signals from the processor 402 via an output port interface 416.

A number of program modules may be stored in the system memory 404, any other computer-readable media associated with the storage device 411 (e.g., a hard disk drive), and/or any other data source accessible by computing device 401. The program modules may include an operating system 417. The program modules may also include an information display program module 419 comprising computer-executable instructions for displaying images or other information on a display screen. Other aspects of the exemplary embodiments of the invention may be embodied in a touch screen control program module 421 for controlling the primary and secondary illumination systems, detector assemblies, and/or for calculating touch locations, resolving multitouch scenarios (e.g., by implementing an embodiment of method 300), and discerning interaction states relative to the touch screen based on signals received from the detectors.

In some embodiments, a DSP unit is included for performing some or all of the functionality ascribed to the Touch Panel Control program module 421. As is known in the art, a DSP unit 405 may be configured to perform many types of calculations including filtering, data sampling, and triangulation and other calculations and to control the modulation and/or other characteristics of the illumination systems. The DSP unit 405 may include a series of scanning imagers, digital filters, and comparators implemented in software. The DSP unit 405 may therefore be programmed for calculating touch locations and discerning other interaction characteristics as known in the art.

The processor 402, which may be controlled by the operating system 417, can be configured to execute the computer-executable instructions of the various program modules. Methods in accordance with one or more aspects of the present subject matter may be carried out due to execution of such instructions. Furthermore, the images or other information displayed by the information display program module 419 may be stored in one or more information data files 423, which may be stored on any computer readable medium associated with or accessible by the computing device 401.

When a user touches on or near the touch screen, a variation will occur in the intensity of the energy beams that are directed across the surface of the touch screen in one or more detection planes. The detectors are configured to detect the intensity of the energy beams reflected or otherwise scattered across the surface of the touch screen and should be sensitive enough to detect variations in such intensity. Information signals produced by the detector assemblies and/or other components of the touch screen display system may be used by the computing device 401 to determine the location of the touch relative to the touch area 431. Computing device 401 may also determine the appropriate response to a touch on or near the screen.

In accordance with some implementations, data from the detection system may be periodically processed by the computing device 401 to monitor the typical intensity level of the energy beams directed along the detection plane(s) when no touch is present. This allows the system to account for, and thereby reduce the effects of, changes in ambient light levels and other ambient conditions. The computing device 401 may optionally increase or decrease the intensity of the energy beams emitted by the primary and/or secondary illumination systems as needed. Subsequently, if a variation in the intensity of the energy beams is detected by the detection systems, computing device 401 can process this information to determine that a touch has occurred on or near the touch screen.

The location of a touch relative to the touch screen may be determined, for example, by processing information received from each detection system and performing one or more well-known triangulation calculations plus resolving multitouch scenarios as noted above. The location of the area of decreased energy beam intensity relative to each detection system can be determined in relation to the coordinates of one or more pixels, or virtual pixels, of the display screen. The location of the area of increased or decreased energy beam intensity relative to each detector may then be triangulated, based on the geometry between the detection systems to determine the actual location of the touch relative to the touch screen. Any such calculations to determine touch location can include algorithms to compensation for discrepancies (e.g., lens distortions, ambient conditions, damage to or impediments on the touch screen or other touched surface, etc.), as applicable.

The above examples referred to various illumination sources and it should be understood that any suitable radiation source can be used. For instance, light emitting diodes (LEDs) may be used to generate infrared (IR) radiation that is directed over one or more optical paths in the detection plane. However, other portions of the EM spectrum or even other types of energy may be used as applicable with appropriate sources and detection systems.

Several of the above examples were presented in the context of a touch-enabled display. However, it will be understood that the principles disclosed herein could be applied even in the absence of a display screen when the position of an object relative to an area is to be tracked. For example, the touch area may feature a static image or no image at all.

In several examples, secondary illumination systems are shown as separate from the primary illumination system. In some embodiments, the “primary illumination system” and “secondary illumination system” may use some or all of the same components. For example, a detector assembly may comprise a light detector with a plurality of sources, such as one or more sources located on either side of the detector. A first pattern of light can be emitted by using the source(s) on both sides of the detector. The light emitted across the touch area can be changed to a second pattern of light by using the source(s) on one side of the detector, but not the other, to obtain changes in shadow length for range estimation.

The various systems discussed herein are not limited to any particular hardware architecture or configuration. As was noted above, a computing device can include any suitable arrangement of components that provide a result conditioned on one or more inputs. Suitable computing devices include multipurpose microprocessor-based computer systems accessing stored software, but also application-specific integrated circuits and other programmable logic, and combinations thereof. Any suitable programming, scripting, or other type of language or combinations of languages may be used to implement the teachings contained herein in software.

Embodiments of the methods disclosed herein may be executed by one or more suitable computing devices. Such system(s) may comprise one or more computing devices adapted to perform one or more embodiments of the methods disclosed herein. As noted above, such devices may access one or more computer-readable media that embody computer-readable instructions which, when executed by at least one computer, cause the at least one computer to implement one or more embodiments of the methods of the present subject matter. When software is utilized, the software may comprise one or more components, processes, and/or applications. Additionally or alternatively to software, the computing device(s) may comprise circuitry that renders the device(s) operative to implement one or more of the methods of the present subject matter.

Any suitable computer-readable medium or media may be used to implement or practice the presently-disclosed subject matter, including, but not limited to, diskettes, drives, magnetic-based storage media, optical storage media, including disks (including CD-ROMS, DVD-ROMS, and variants thereof), flash, RAM, ROM, and other memory devices, and the like.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art

What is claimed:

1. A method of determining multiple touch points, the method comprising:
detecting a first shadow resulting from an interruption of light at a first point in a touch area using a first detector;
changing light traveling in the touch area so that a length of at least one shadow changes;
based on the length of the shadow as changed, calculating a distance from the first point to the first detector; and
using the distance as calculated to validate a potential touch position coordinate for the first point.

2. The method of determining multiple touch points as set forth in claim 1, further comprising:
detecting a second shadow resulting from the interruption of light at the first point in the touch area using a second detector;
detecting a third shadow resulting from an interruption of light at a second point in the touch area using the first detector, the interruption at the second point occurring during a time interval during which the first and second shadows are detected;
detecting a fourth shadow resulting from the interruption of light at the second point in the touch area using the second detector;
determining four potential touch position coordinates based on the directions of the first and third shadows relative to the first detector and the directions of the second and fourth shadows relative to the second detector;
wherein whilst using the distance as calculated to validate a potential position coordinate for the first point, two actual touch positions are determined from the four potential touch positions.

3. The method set forth in claim 2, wherein changing light traveling in the touch area comprises emitting light from a secondary illumination source positioned a distance from the detector.

4. The method set forth in claim 3,
wherein prior to changing light traveling in the touch area, light is emitted from a primary illumination source; and
wherein while light is emitted from the secondary illumination source, light is not illuminated from the primary illumination source.

5. The method set forth in claim 3, wherein the primary and secondary illumination source are positioned on opposite sides of the detector.

6. The method set forth in claim 3, wherein determining a distance from the first point to the first detector is based on a function of a change in length of the shadow as related to the distance between the secondary illumination source and the first detector.

7. The method set forth in claim 2, wherein determining four potential touch position coordinates based on the directions of the first and third shadows relative to the first detector and the directions of the second and fourth shadows comprises triangulating the four potential touch positions coordinates from intersections between ray traces associated with the shadows.

8. A touch detection system, comprising:
a retroreflector positioned along at least one edge of a touch surface in a touch area;
a light detection system having an optical center and positioned to image the retroreflector;
an illumination system configured to emit light across the touch surface so that at least some of the light from the illumination system is retroreflected to the light detection system in the absence of an object in the touch area; and
a computing system interfaced with the light detection system and the illumination system, the computing system configured to determine a distance from the light detection system to a point at which light in the touch area has been interrupted based on: (i) a first pattern of detected light indicating an interruption in a first pattern of light from the illumination system due to an object at the point and (ii) a second pattern of detected light representing an interruption in a second pattern of light from the illumination system due to the object at the point.

9. The touch detection system set forth in claim 8, wherein the first pattern of light is emitted from a primary illumination source of the illumination system and the second pattern of light is emitted from a secondary illumination source of the illumination system, the secondary illumination source located a known distance from a detector of the light detection system.

10. The touch detection system set forth in claim 9, wherein the first and second pattern of detected light are evaluated to determine a change in shadow length, and
wherein the distance to the point at which light in the touch area has been interrupted is determined based on a function of the change in shadow length as related to the distance between the secondary illumination source and the light detection system.

11. The touch detection system set forth in claim 8,
wherein the light detection system and the illumination system are incorporated into a single optical unit and the system comprises two of the optical units, each optical unit positioned remote from the retroreflector and each other.

12. The touch detection system set forth in claim 11, wherein the light detection system comprises a light detector and the illumination system comprises a plurality of light sources, the light sources positioned on opposite sides of the light detector.

13. The touch detection system set forth in claim 11, wherein the computing system is further configured to:
(i) determine four potential touch points based on triangulation from shadows detected by the optical unit based on interruptions in light from the primary illumination systems,
(ii) determine two estimated distances, each estimated distance corresponding to one of two simultaneous interruptions, and
(iii) identify two of the potential touch points as actual touch points based on the estimated distances.

14. The touch detection system set forth in claim 13, wherein the actual touch points are identified based on a distance metric determined using the estimated distances as determined from changes in shadow length and calculated distances for each potential touch point calculated based on triangulation.

15. A computer readable medium embodying program code executable by a computer system, the program code comprising:
program code for accessing detection data from two light detectors and identifying two shadows detected by each detector, the shadows due to interruptions in a first pattern of light traveling in a touch area;
program code for directing a light source to illuminate the touch area using a second pattern of light;
program code for accessing detection data from one light detector and identifying a change in the size of a shadow, the change in size occurring when the second pattern of light illuminates the touch area; and
program code for determining a distance from a point in the touch area to the detector based on the change in size of the shadow.

16. The computer-readable medium set forth in claim 15, further comprising:
program code for identifying a plurality of potential touch points from the detected shadows; and
program code for identifying a subset of the potential touch points as actual touch points based on the distance determined from a change in size of the shadow.

17. The computer-readable medium set forth in claim 16, wherein the program code for identifying a plurality of potential touch points from the detected shadows identifies the potential touch points through triangulation.

18. The computer-readable medium set forth in claim 15, further comprising:
program code for directing a light source to illuminate the touch area using the first pattern of light,
wherein the first and second patterns of light are emitted at different times.

19. The computer-readable medium set forth in claim 18, wherein the program code for directing the light source to illuminate the touch area using first and second patterns of light directs a plurality of light sources included in a single optical unit to emit light so that, when the second pattern of light is to be used, at least one light source in the optical unit is not illuminated.
